(19) United States
(12) Patent Application Publication
(10) Pub. No.: US 2016/0025904 A1
(43) Pub. Date: Jan. 28, 2016

(54) OPTICAL SHEET STRUCTURE

(71) Applicant: LMS CO., LTD, Pyeongtaek-si Gyeonggi-do (KR)

(72) Inventors: Dong Cheol LEE, Suwon-si, Gyeonggi-do (KR); Jee Hong MIN, Seongnam-si, Gyeonggi-do (KR); Jae Ho KO, Osan-si, Gyeonggi-do (KR); Jung Min LEE, Pyeongtaek-si, Gyeonggi-do (KR); Jang Hee CHO, Suwon-si, Gyeonggi-do (KR)

(21) Appl. No.: 14/772,458

(22) PCT Filed: Mar. 3, 2014
(86) PCT No.: PCT/KR2014/001717

§ 371 Date: Sep. 3, 2015

(30) Foreign Application Priority Data
Mar. 5, 2013 (KR) 10-2013-0023367

(51) Int. Cl. G02B 5/02

(52) U.S. Cl. CPC G02B 5/021; G02B 5/0284

(57) ABSTRACT

The present invention relates to an optical sheet structure for minimizing optical interferences, which includes: a base substrate; a structural pattern formed on the upper side of the base substrate; and an optical interference preventive part formed on the underside of the base substrate having a plurality of concave regions separately formed.

### TECHNICAL FIELD

The present invention relates to an optical sheet structure, and more particularly, to an optical sheet structure that can minimize optical interference by forming a plurality of division areas on a side of an optical sheet.

### BACKGROUND ART

A liquid crystal display is a device used for a notebook, a personal computer, a smart phone, or a TV and its characteristics have been improved every year in accordance with increasing demands.

The liquid crystal panel of a liquid crystal display, which is a non-light emitting device, requires a backlight unit for the structure. A backlight unit is composed of various optical systems. Further, a backlight unit uses optical films arranged periodically to improve luminance.

FIG. 1 is a view schematically showing the configuration of a liquid crystal display of the related art.

As shown in FIG. 1, a backlight unit includes a light emitting source 1, a reflective plate 2, a light guide plate 3, a diffusion sheet 4, a first optical sheet 5, a second optical sheet 6, a reflective polarizer 7, and a liquid crystal panel 8.

The light emitting source 1 is a device emitting visible light and a Light Emitting Diode (LED) and a Cold Cathode Fluorescent Lamp (CCFL) may be selectively used as the light emitting source 1.

Light discharged from the light emitting source 1 travels into the light guide plate 3 and generates total reflection in the light guide plate 3 and light traveling into the surface inside the light guide plate 3 at an incident angle smaller than a critical angle is transmitted without total reflection, so the light is emitted up and down.

The reflective plate 2 improves optical efficiency by reflecting the light, which is emitted down, back into the light guide plate 3.

The diffusion sheet 4 makes luminance uniform and increases the viewing angle by diffusing light emitted through the top of the light guide plate 3 and light passing through the diffusion sheet 4 deteriorates front emission luminance.

The first optical sheet 5 is composed of a base and a structural pattern and primarily collects and discharges light so that the incident light from the diffusion sheet 4 is refracted and vertically travels.

Further, the structural pattern is formed integrally on the top of the base and vertically refracts light, which travels through the base, to discharge the light.

The structural pattern usually has a triangular cross-section and the vertex angle of the triangle is usually around 90 degrees.

The second optical sheet 6 has the same shape as the first optical sheet 5 and secondarily collects and discharges the light primarily collected by the first optical sheet 5 to increase the luminance. In this case, the periods, heights, and refractive indexes of the first optical sheet 5 and the second optical sheet 6 may be different, if necessary.

The first optical sheet 5 and the second optical sheet 6 may be arranged such that the extension direction of the structural pattern of the first optical sheet 5 and the extension direction of the structural pattern of the second optical sheet 6 cross each other in order to further increase the luminance.

The reflective polarizer 7 that selectively reflects incident light is disposed on the second optical sheet 6 and the reference numeral ‘8’ in FIG. 1 indicates a liquid crystal panel.

In the display device having the configuration shown in the figure, some of incident light from the outside are reflected from the second optical sheet 6 and discharged to the outside. In this case, as in FIG. 2A, there is a problem of Newton-ring due to interference between the light reflecting from the top of the base 6a and the light reflecting from the rear side.

Accordingly, in order to solve this problem in the related art, as shown in FIGS. 2B and 2C, grooves may be formed on the rear side of the base 6a of the optical sheet 6 to suppress the interference by light. However, even in this related art, it can be seen that interference can be caused by reflection of light at the portions without the grooves on the rear side of the base 6a, so Newton-ring cannot be prevented.

Therefore, it has been required to develop an optical sheet that can effectively suppress Newton-ring by minimizing interference by light.

### DISCLOSURE

### Technical Problem

An embodiment of the present invention is directed to an optical sheet structure that can minimize interference by incident light and suppress a defect such as Newton-ring by forming a plurality of division areas on the rear side of a base of an optical sheet, in order to solve the problems with optical sheets of the related art.

It should be noted that objects of the present invention are not limited to the above-mentioned object and other objects of the present invention will be apparent to those skilled in the art from the following descriptions.

### Technical Solution

According to an aspect of the present invention, an optical sheet structure includes: a base; a structural pattern formed on the base; and an anti-optical interference portion formed on the rear side of the base and having a plurality of independent convex division areas.

It is preferable that the division areas of the anti-optical interference portion are formed adjacent to each other throughout the entire rear side of the base.

It is preferable that the division areas of the anti-optical interference portions are separated by line-shaped grooves.

It is preferable that a sub-anti-optical interference portion that can disperse incident light is formed on the anti-optical interference portion.

It is preferable that the sub-anti-optical interference portion is a groove.

It is preferable that apexes of pattern elements of the structural pattern have height differences in the longitudinal direction of the pattern.

It is preferable that the apexes of the pattern elements of the structural pattern make waves with a predetermined period in the longitudinal direction of the pattern.

It is preferable that at least some of pattern elements of the structural pattern have different apex heights from the others.

According to another aspect of the present invention, an optical sheet structure includes: a first optical sheet including a first base and a first structural pattern formed on the first base; and a second optical sheet formed under the first optical sheet and including a second base and a second structural pattern formed on the second base, and an anti-optical interference portion having a plurality of independent convex division areas is formed on the rear side of at least one of the first base and the second base.

It is preferable that the division areas of the anti-optical interference portion are formed adjacent to each other throughout the entire rear side of the base.

It is preferable that the division areas of the anti-optical interference portions are separated by line-shaped grooves.

It is preferable that a sub-anti-optical interference portion that can disperse incident light is formed on the anti-optical interference portion.

It is preferable that the sub-anti-optical interference portion is a groove.

It is preferable that the first optical sheet and the second optical sheet are bonded.

It is preferable that the first optical sheet and the second optical sheet are bonded through an adhesive layer.

It is preferable that the second structural pattern is an adhesive.

It is preferable that apexes of pattern elements of the second structural pattern have height differences in the longitudinal direction of the pattern.

It is preferable that the apexes of the pattern elements of the second structural pattern make waves with a predetermined period in the longitudinal direction of the pattern.

It is preferable that at least some of pattern elements of the second structural pattern have different apex heights from the others.

It is preferable that the first optical sheet and the second optical sheet are alternately arranged.

### Advantageous Effects

The present invention has the following effects to solve the problems described above.

Unlike optical sheets of the related art, an anti-optical interference portion having a plurality of convex division areas defined by continuous line-shaped grooves is formed on the rear side of a base of an optical sheet of the present invention, so it is possible to minimize optical interference.

Therefore, it is possible to effectively suppress a defect such as Newton-ring that is a display defect of a liquid crystal display due to optical interference.

### BRIEF DESCRIPTION OF THE DRAWINGS

FIG. 1 is a schematic view showing a common configuration of a backlight unit of the related art.

FIGS. 2A and 2B are schematic views showing interference due to reflection of light in an optical sheet structure of the related art, and FIG. 2C is a surface picture of FIG. 2B.

FIG. 3 is a schematic view showing a cross-section of an optical sheet structure according to an embodiment of the present invention.

FIGS. 4A to 4D are pictures schematically showing an example of an anti-optical interference portion of an optical sheet of the present invention.

FIG. 5 is a surface picture of an anti-optical interference portion corresponding to FIG. 4A.

FIG. 6 is a schematic view showing a cross-section of an optical sheet structure according to another embodiment of the present invention.

FIGS. 7A and 7B are views schematically showing reflection paths of reflecting light for incident light in an optical sheet structure of the present invention.

FIGS. 8A and 8B are schematic view showing the shape of a structural pattern of an optical sheet of the present invention.

FIG. 9 is a schematic view showing a cross-section of an optical sheet structure according to another embodiment of the present invention.

FIG. 10 is a schematic view showing a cross-section of an optical sheet structure according to another embodiment of the present invention.

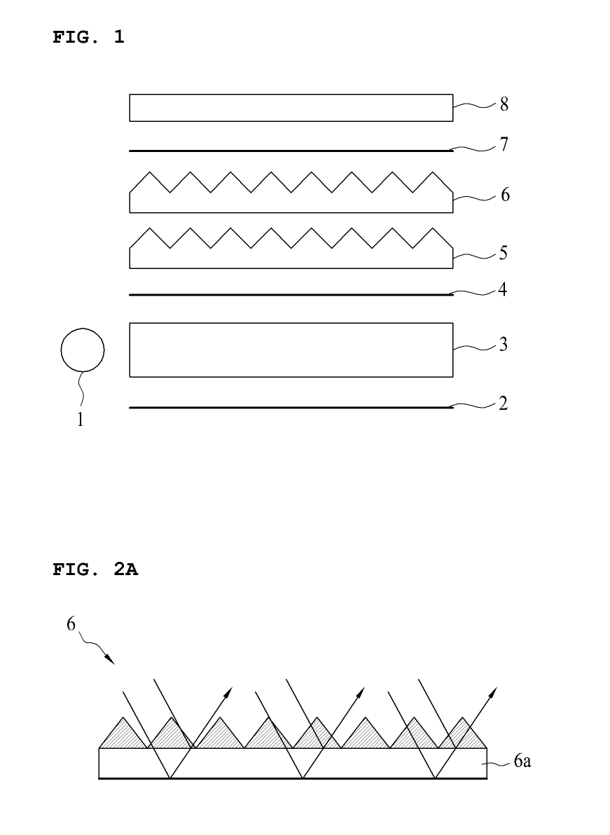

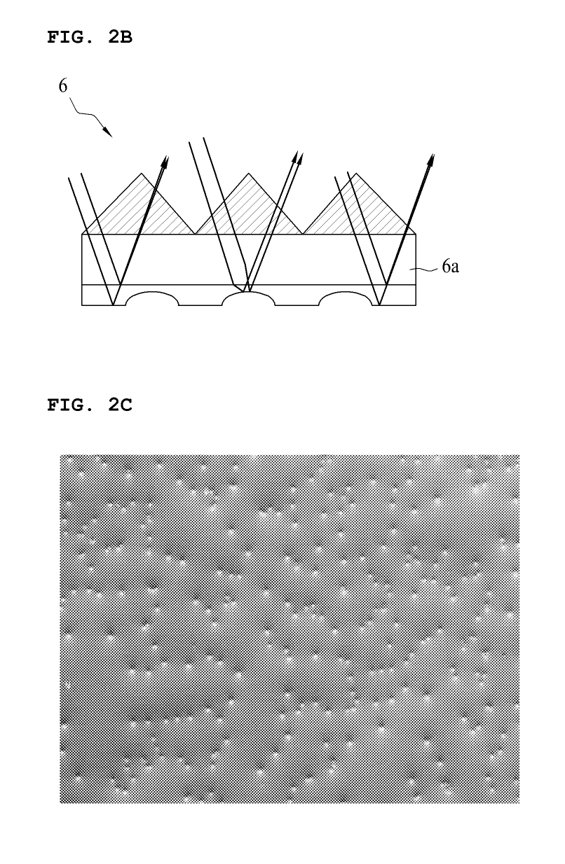

### BEST MODE FOR THE INVENTION

Preferred embodiments of an optical sheet structure having an anti-optical interference portion to be able to suppress Newton-ring in accordance with the present invention are described with reference to the accompanying drawings. However, the embodiments are not intended to specifically limit the present invention, but intended to help more clearly understanding the present invention.

In the description of the embodiments, like components are given like names and reference numerals and they are not additionally described.

First, the configuration of an optical sheet structure having an anti-optical interference portion of the present invention is described hereafter with reference to FIGS. 3 to 7.

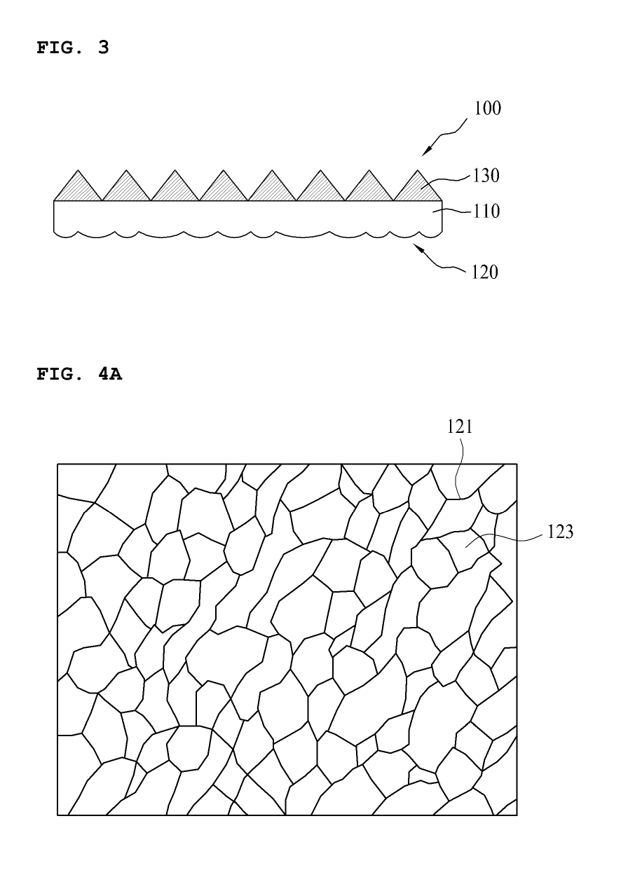

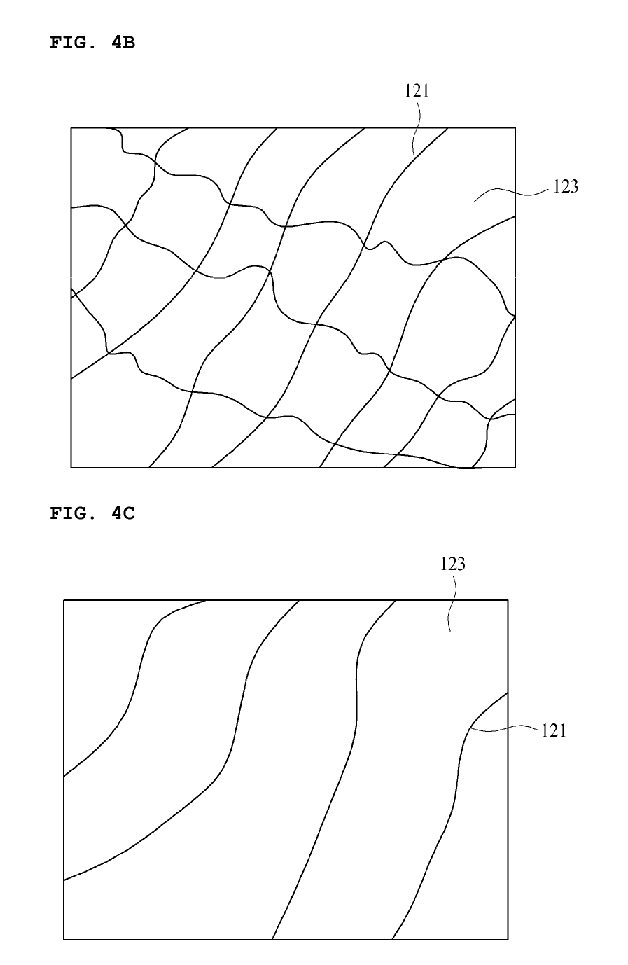

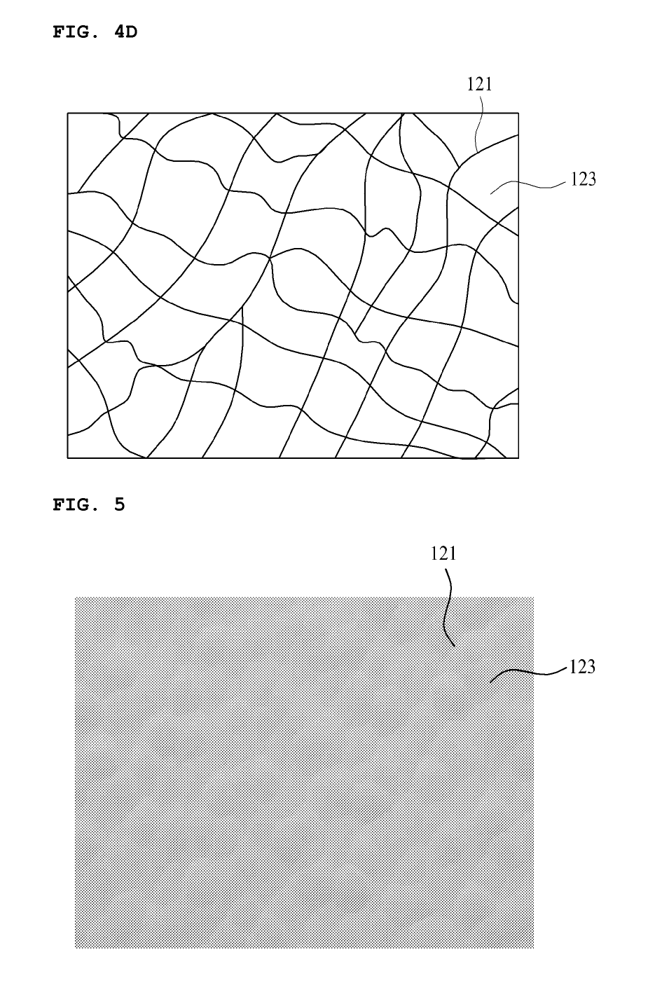

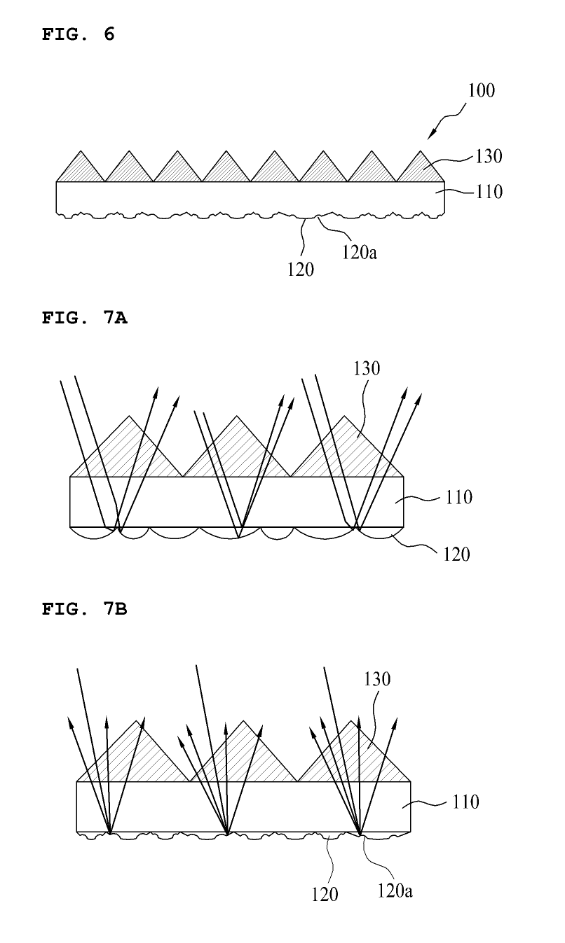

FIG. 3 is a schematic view showing a cross-section of an optical sheet structure according to an embodiment of the present invention, FIGS. 4A to 4D are pictures schematically showing an example of an anti-optical interference portion of an optical sheet of the present invention, FIG. 5 is a surface picture of an anti-optical interference portion corresponding to FIG. 4A, FIG. 6 is a schematic view showing a cross-section of an optical sheet structure according to another embodiment of the present invention, and FIGS. 7A and 7B are view schematically showing a reflection path of reflecting light for incident light in an optical sheet structure of the present invention.

As shown in FIG. 3, an optical sheet structure 100 of the present invention includes a base 110, a structural pattern 130 formed on the base 110, and an anti-optical interference portion 120 formed on the rear side of the base 110 and having a plurality of independent convex division areas.

First, the optical sheet structure of the present invention includes the structural pattern 130 formed on the base 110. The base 110 may be made of various light transmissive material well known in the art, not limited to specific materials.

In the present invention, the structural pattern 130 vertically refracts and discharges incident light coming from under it and usually has a cross-section in a triangular prism pattern. However, the present invention is not limited thereto and various shapes of structural pattern may be used.

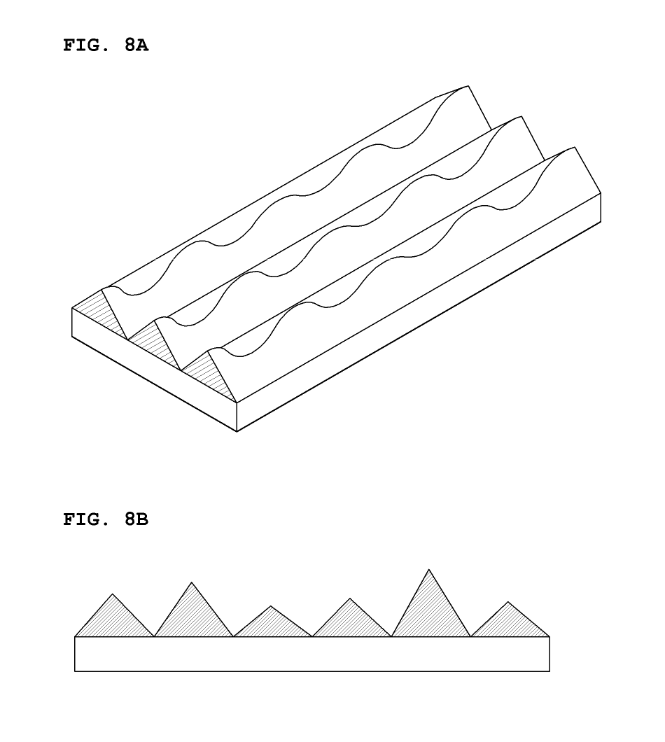

It is preferable in the present invention that the apexes of the pattern elements of the structural pattern 130 have height differences in the longitudinal direction of the pattern, as in FIG. 8A. According to this shape, it is possible to suppress all defects due to friction with another optical part disposed thereon.

More preferably, the apexes of the pattern elements of the structural pattern 130 may make waves with a predetermined period in the longitudinal direction of the pattern.

Further, as in FIG. 8B, it is preferable that at least some of the pattern elements of the structural pattern 130 have different apex heights from the adjacent others. According to this configuration, it is possible to prevent defects such as ridge separation due to contact between upper and lower sheets.

The optical sheet structure 100 of the present invention includes the anti-optical interference portion 120 on the rear side of the base 110.

The anti-optical interference portion 120 is formed on the rear side of the base 110 and makes it possible to effectively suppress a display defect such as Newton-ring by minimizing optical interference due to reflection of light traveling into a liquid crystal display from the outside.

FIGS. 4A and 4D are pictures schematically showing an example of the anti-optical interference portion 120.

As shown in the figures, the anti-optical interference portion 120 of the present invention has a plurality of independent convex division areas 123. The division areas may be formed in a circular or elliptical shape, or may have other various shapes such as a diamond and a polygon. Further, the division areas 123 are not limited in size or shape and may be formed in any size and shape as long as they can prevent optical interference by dispersing and reflecting incident light on the rear side of the base 110.

FIG. 5 is a surface picture of the anti-optical interference portion 120 corresponding to FIG. 4A. As in FIG. 5, it can be seen that the division areas 123 of the present invention are formed non-uniformly and convexly in different sizes and shapes on the rear side of the base 110. However, FIG. 5 shows just an embodiment of the present invention and the size, shape, and distribution of the division areas 123 may be made uniformly in the present invention.

Further, as in FIGS. 4A to 4D, it is preferable that the division areas 123 of the anti-optical interference portion 120 are formed adjacent to each other throughout the rear side of the base 110.

It is preferable that the division areas 123 of the anti-optical interference portion are separated by line-shaped grooves 121.

The division areas 123 may generally exist in an embossing type in the present invention. Further, it is preferable to set the gap between the grooves 121 of the division areas 123 in the range of 20 to 50 μm.

FIG. 6 is a schematic view showing a cross-section of an optical sheet structure according to another embodiment of the present invention.

As shown in FIG. 6, in the optical sheet structure of the present invention, a sub-anti-optical interference portion 120a that can disperse light traveling into the surface of the anti-optical interference portion 120 may be formed. The sub-anti-optical interference portion 120a may provide more excellent anti-optical interference effect.

In the present invention, the sub-anti-optical interference portion 120a is not limited to specific form or shape, but preferably has a groove shape. Accordingly, the groove shape may be implemented in various shapes such as a circle, an ellipse, a rectangle, and a triangle.

FIGS. 7A and 7B are view schematically showing reflection paths of reflecting light for incident light in an optical sheet structure of the present invention.

As shown in FIG. 7A, when the anti-optical interference portion 120a having a plurality of division areas is formed on the rear side of the base 110, it can be seen that overlapping of light reflection paths is suppressed, and accordingly, Newton-ring is reduced.

FIG. 7B is a view showing light reflection paths when the sub-anti-optical interference portion 123a is formed on the anti-optical interference portion 120, in which it can be seen that overlapping of light reflection paths may be more effectively suppressed as compared with when the sub-anti-optical interference portion 123a is not formed, and accordingly Newton-ring may be more effectively suppressed.

Newton-ring is a phenomenon due to interference by light reflecting from two surfaces, in which bright and dark rings are alternately formed.

That is, when light reflecting from surfaces makes constructive interference, the surfaces are shown bright, and when the light makes destructive interference, the surfaces are shown dark, and the bright and dark parts are usually alternately shown.

According to the present invention, as shown in FIGS. 7A and 7B, it can be seen that light reflection paths of reflecting light are changed by forming an anti-optical interference portion on the rear side of a base of an optical sheet, so Newton-ring may be more effectively reduced.

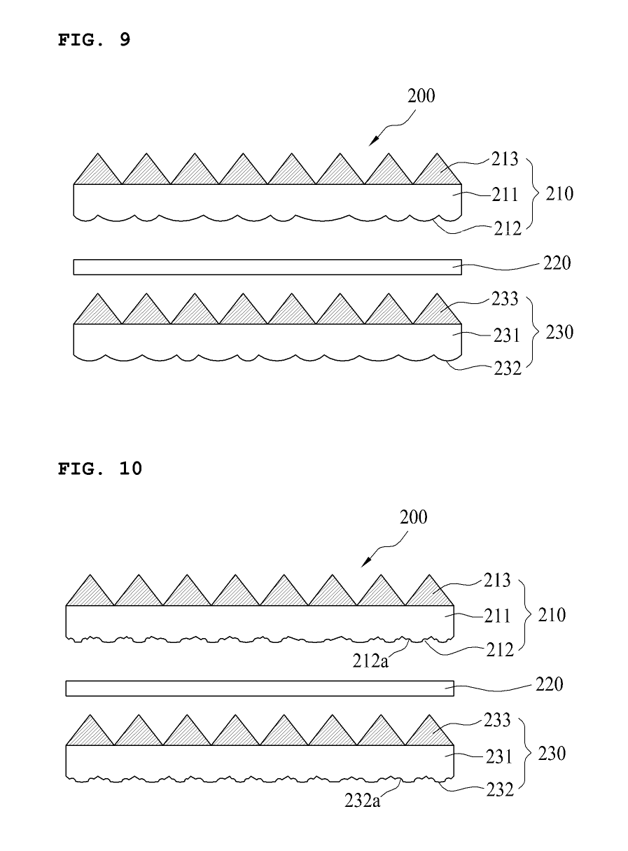

FIG. 9 is a schematic view showing a cross-section of an optical sheet structure according to another embodiment of the present invention.

As shown in FIG. 9, an optical sheet structure 200 of the present invention includes a first optical sheet 210 and a second optical sheet 230 under the first optical sheet.

The first optical sheet 210 includes a first base 211 and a first structural pattern 213 formed on the first base 211 and the second optical sheet 230 includes a second base 231 and a second structural pattern 233 formed on the second base 231.

The optical sheet structure of the present invention is characterized in that anti-optical interference portion 212 and 232 having a plurality of independent convex division areas are formed on the rear side of at least one of the first base 211 and the second base 231. Since the anti-optical interference portions 212 and 232 are formed, as described above, overlapping of light reflection paths of incident light is prevented and optical interference may be avoided. Further, the division areas are also described above.

In the present invention, it is preferable that the division areas of the anti-optical interference portions 212 and 232 are formed adjacent to each other throughout the rear sides of the bases 211 and 231.

It is preferable that the division areas of the anti-optical interference portions 212 and 232 are separated by line-shaped grooves.

In the present invention, as shown in FIG. 10, it is preferable that sub-anti-optical interference portions 212a and 232a that can disperse light traveling into the surfaces of the anti-optical interference portions 212 and 232 are formed. The sub-anti-optical interference portions 212a and 232a suppress overlapping of light reflection paths, so optical interference may be minimized.

It is preferable in the present invention that the sub-anti-optical interference portions 212a and 232a are grooves.

It is preferable in the present invention that the first optical sheet 210 and the second optical sheet 230 are bonded. By bonding the upper and lower sheets, a manufactured product may be made compact.

The present invention is not limited to the detailed method of bonding the first optical sheet 210 and the second optical sheet 230. For example, as in FIG. 9, the upper and lower sheets 210 and 230 may be bonded through an adhesive layer 220. Alternatively, the second structural pattern 233 of the second optical sheet 230 may be an adhesive. The adhesive may be a thermosetting adhesive or a thermoplastic adhesive and the present invention is not limited to specific types of adhesives.

As in FIG. 8A, it is preferable that the apexes of the pattern elements of the second structural pattern 233 have height differences in the longitudinal direction of the pattern. It is preferable that the apexes of the pattern elements of the second structural pattern 233 make waves with a predetermined period in the longitudinal direction of the pattern.

Further, as in FIG. 8B, it is preferable that at least some of the pattern elements of the second structural pattern 233 have different apex heights from the adjacent others.

It is preferable that the first structural pattern 231 and the second structural pattern 233 are alternately arranged.

As described above, according to an optical sheet structure of the present invention, it is possible to minimize optical interference by suppressing overlapping of light reflection paths of incident light by forming an anti-optical interference portion on the rear side of a base, and accordingly, it is possible to remove a surface defect of a liquid crystal display such as Newton-ring.

Although preferred embodiments of the present invention were described above, the present invention may be implemented in various ways without departing from the scope of the present invention other than the embodiments described above. Therefore, the embodiments should be construed as examples, not specifying the present invention, and the present invention is not limited thereto and may be modified within the scope of claims or a range equivalent to the scope.

1. An optical sheet structure comprising:
a base;
a structural pattern formed on the base; and
an anti-optical interference portion formed on the rear side of the base and having a plurality of independent convex division areas.

2. The optical sheet structure of claim 1, wherein the division areas of the anti-optical interference portion are formed adjacent to each other throughout the entire rear side of the base.

3. The optical sheet structure of claim 1, wherein the division areas of the anti-optical interference portion are separated by line-shaped grooves.

4. The optical sheet structure of claim 1, wherein a sub-anti-optical interference portion that can disperse incident light is formed on the anti-optical interference portion.

5. The optical sheet structure of claim 4, wherein the sub-anti-optical interference portion is a groove.

6. The optical sheet structure of claim 1, wherein apexes of pattern elements of the structural pattern have height differences in the longitudinal direction of the pattern.

7. The optical sheet structure of claim 6, wherein the apexes of the pattern elements of the structural pattern make waves with a predetermined period in the longitudinal direction of the pattern.

8. The optical sheet structure of claim 1, wherein at least some of pattern elements of the structural pattern have different apex heights from the adjacent others.

9. An optical sheet structure comprising:
a first optical sheet including a first base and a first structural pattern formed on the first base; and
a second optical sheet formed under the first optical sheet and including a second base and a second structural pattern formed on the second base, and
an anti-optical interference portion having a plurality of independent convex division areas is formed on the rear side of at least one of the first base and the second base.

10. The optical sheet structure of claim 9, wherein the division areas of the anti-optical interference portion are formed adjacent to each other throughout the entire rear side of the base.

11. The optical sheet structure of claim 9, wherein the division areas of the anti-optical interference portion are separated by line-shaped grooves.

12. The optical sheet structure of claim 9, wherein a sub-anti-optical interference portion that can disperse incident light is formed on the anti-optical interference portion.

13. The optical sheet structure of claim 10, wherein the sub-anti-optical interference portion is a groove.

14. The optical sheet structure of claim 9, wherein the first optical sheet and the second optical sheet are bonded.

15. The optical sheet structure of claim 14, wherein the first optical sheet and the second optical sheet are bonded through an adhesive layer.

16. The optical sheet structure of claim 14, wherein the second structural pattern is an adhesive.

17. The optical sheet structure of claim 9, wherein apexes of pattern elements of the second structural pattern have height differences in the longitudinal direction of the pattern.

18. The optical sheet structure of claim 17, wherein the apexes of the pattern elements of the second structural pattern make waves with a predetermined period in the longitudinal direction of the pattern.

19. The optical sheet structure of claim 9, wherein at least some of pattern elements of the second structural pattern have different apex heights from the adjacent others.

20. The optical sheet structure of claim 9, wherein the first structural pattern and the second structural pattern are alternately arranged.
